(19) United States
(12) Patent Application Publication
(10) Pub. No.: US 2026/0204045 A1
(43) Pub. Date: Jul. 16, 2026

(54) FOSSIL RECOGNITION METHOD WITH DEEP LEARNING PROCESSES

(71) Applicant: TURKlYE PETROLLERl ANONIM ORTAKLIGI, Çankaya, Ankara (TR)

(72) Inventors: Tugba Aksel TÜRKECAN, Çankaya, Ankara (TR); Ezgi Ekiz EMIROGLU, Çankaya, Ankara (TR); Ramazan Gökberk CINBIS, Çankaya, Ankara (TR)

(21) Appl. No.: 19/133,636

(22) PCT Filed: Nov. 14, 2023
(86) PCT No.: PCT/TR2023/051320

§ 371 Date: May 28, 2025

(30) Foreign Application Priority Data
Nov. 29, 2022 (TR) 2022/018112

(51) Int. Cl. G06V 10/764; G06V 10/774; G06V 10/776; G06V 10/82; G06V 10/94; G06V 20/60

(52) U.S. Cl. CPC G06V 10/764; G06V 10/774; G06V 10/776; G06V 10/82; G06V 10/945; G06V 20/60

(57) ABSTRACT

A method of computer-based fossil identification with deep learning processes is disclosed, which is thought to bring great convenience and innovation to paleontological and stratigraphic studies. According to the method of the present invention, from the photographs of microfossils (single-celled fossils) belonging to the acritarch and chitinozoan groups, it is possible to automatically predict which genus the individual in the photograph belongs to. In micropaleontological studies, the genus and species determination of fossils can be made by experts under the microscope. Fossil identification is a time-consuming and highly specialized process. With this system developed using deep learning and computer vision techniques, these problems are prevented, the margin of error observed in the definitions can be reduced, and it may be sufficient to have a lower level of expertise required during the definitions.

### TECHNICAL FIELD

The invention relates to a method that enables fossil recognition by deep learning processes.

### TECHNICAL BACKGROUND

When the state of the technique is examined, a study similar to this invention is not found in the national scope. In the international context, there is a study developed in 2019 with the code “CN201910263962.9A”, which is similar to this study but is very different in quality. In this study, fossil identification can be made from photographs and videos of macrofossils (fossils visible to the naked eye). However, in our study, a distinction can be made in the order of genus (a more detailed description) from the images of microfossils (fossils that cannot be seen with the naked eye) under the microscope. In addition, the deep learning based techniques used in this invention was also used in the software work with the code CN201910263962.9A. Deep Learning based computer vision techniques are commonly used during the development of many software.

All kinds of living remains and traces that lived in the geological times and were preserved in sedimentary rocks after death are called fossils. Biostratigraphy is a very important earth science that classifies rock clusters according to their fossil content. The change of living communities in geological time forms the basis of biostratigraphy. The change of living communities went through in geological time forms the basis of biostratigraphy. The presence of a particular species, its evolutionary stage, or the absence of a species can be used to age sediments. Fossils are divided into microfossils and macrofossils according to their size. Macrofossils are fossils that can be viewed with the naked eye. Microfossils, on the other hand, are living remains whose characteristic features can only be observed under a microscope. Paleontology is the branch of science that examines fossils and reveals their structure, biology, morphology, genetic relationships, and their distribution in time and space. One of the main tasks of paleontology is to classify fossils into meaningful groups. A taxonomic hierarchy has been established among these separated groups, as it facilitates classification and expresses originary dependence (order, division, class, order, family, genus, and species). In paleontology, morphological similarities and differences are essentially used for the creation of this hierarchy. In particular, determining the genus and species of fossils under the microscope in micropaleontological studies is a very time-consuming and specialized process. In addition, in cases where the field of expertise is not sufficient, the margin of error may be greater during the manual fossil identification process.

### OBJECTIVE OF THE INVENTION

The present invention relates to Deep Learning Processes and Fossil Recognition method, which meets the above-mentioned requirements, eliminates all disadvantages and brings some additional advantages.

Within the scope of this invention, “Fossil Vision Software from Photographs (Fossil Vision)” was developed, which is thought to bring great convenience and innovation to paleontological and stratigraphic studies. With the developed invention, from the photographs of microfossils (single-celled fossils) belonging to the achritarch and chitinozoa groups, it is possible to automatically predict which genus the individual in the photograph belongs to. In addition, in conditions where fossil preservation is not good, the closest genera to the individual in the photograph are presented to the user by the program and the program allows the program user (expert person) to confirm which genera can be. In micropaleontological studies, the genus and species determination of fossils can be made by experts under the microscope. Fossil identification is a time-consuming and highly specialized process. With this system developed by using Deep Learning and Computer Vision techniques, these problems are prevented, the margin of error observed in the definitions can be reduced, and it can be sufficient for the required area of expertise during the definitions to be at a lower level.

The main purpose of the invention is to train an assistant learner who makes visual classification using a limited number of examples belonging to the relevant classes. For this purpose, an auxiliary model, a learning method, which uses deep convolutional neural networks to represent pictures and then based on averaging these representations, is proposed.

### BRIEF DESCRIPTION OF THE FIGURES

In order to understand the embodiment of the present invention and its advantages with additional elements, it should be evaluated together with the figures described below.

FIG. 1: Flow chart of the invention

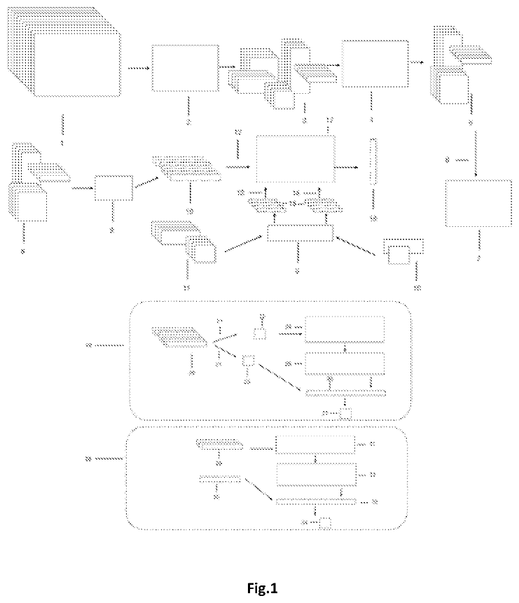

### REFERENCE NUMBERS

1—Raw photographs
2—Manual labeling process
3—Examples of cropped objects with class labels
4—Elimination process by class size
5—Training classes with sample size higher than the specified threshold
6—Validation Assisted Training
7—Convolutional Neural Network
8—Training and validation classes with samples higher than the specified threshold
9—Convolutional Neural Network (frozen)
10—Visual features
11—Classes with fewer examples than the threshold value determined as examples of few-shot learning
12—Validation Assisted Training
13—Inference
14—Test
15—Visual features
16—Unseen test examples of classes with less than the specified threshold value
17—Meta Learner
18—Class labels of unseen instances
19—Meta Learner Training Phase
20—Visual features of examples of training and validation sets of large classes
21—A random subset
22—Training group i
23—Validation group i
24—Averaging of features based on class label
25—Hadamard multiplication (weights in training phase)
26—Classification weights
27—Class scores
28—Meta learner: Test Phase
29—Visual feature from training set of small size classes
30—Visual feature from training set of small size classes
31—Average of features
32—Hadamard multiplication (weights frozen)
33—Classification weights
34—Class scores

### DETAILED DESCRIPTION OF THE INVENTION

In this detailed description, the invention is explained for a better understanding of the subject and without any limiting effect.

The invention relates to a computer-based method that enables fossil identification with deep learning processes.

The basic principle of this invention was designed and developed in such a way that it can identify on a genus basis from photographs of chitinozoa and acritarchs, known as organic shell microfossils, using the “Deep Learning and Computer Vision” technique. In this developed study, the basic building blocks that make up the data set can be described as fossils. In order to understand this invention better, it is necessary to define fossils and the way they are used.

By the help of “Fossil Identification Software from Photograph (Fossil Vision)”, the genus of the individual can be determined from the photographs of the microfossils (single-celled fossils) belonging to the acritarch and chitinozoa groups uploaded to the program. Chitinozoa and acritarchs are included in the study area of palynology (a sub-branch of paleontology) because they are organic-walled fossil mocroorganisms (palynomorphs). Chitinozoa, one of the fossil groups used in “Fossil Identification Software from Photograph (Fossil Vision)”, started to be observed stratigraphically in the Pre-Cambrian period and were not observed in the Cambrian period, but began to be observed again at the very beginning of the Ordovician period (Tremadocian) and continued to be observed until the latest Devonian (late Famenian) period. Biostratigraphically, they are best used for dating in the Early Paleozoic. Chitinozoans preserved in fine-grained sediments indicate marine environments. Chitinozoans have a very simple structure. Chitinozoans, formed around an axis of symmetry, are often described as a vase-like shape and are observed as tubular. These tubes can be spherical, oval, cylindrical and conical in shape. Chitinozoans are mainly composed of an abdominal and oral tube. The part defined as the “abdominal” is the lower part of chitinozoa; the part defined as the “oral tube” forms the upper part of chitinozoa. Outer surface of chitinozoans may be smooth, or they may contain ornamental structures. Oral tubes, on the other hand, consist of sections consisting of collaratte, neck, aperture and ornaments. Extensions called “appendix” can be observed along the abdominal and oral tubes. With the differences and similarities observed in these morphological features, chitinozoans are divided into different genera and species. In particular, the most important reason why chitinozoans are a fossil group used in the “Fossil Identification Software from Photograph (Fossil Vision)” is that, as stated above, chitinozoans are formed around an axis of symmetry, and that the same genus and species have a similar appearance when evaluated in 2 dimensions.

Another fossil group used in the “Fossil Identification Software from Photograph (Fossil Vision)” is acritarchs. Acritarchs are unicellular and organic-walled microorganisms that live in waters (fresh water or seas). The term acritarch is formed by the combination of the Greek words “akritos” meaning uncertain and “arche” meaning origin. The origins of acritarchs are not known exactly and are thought to be polyphyletic. This fossil group, which is divided into subgroups according to their morphological features, is defined at the genus and species level and used in stratigraphic studies. Acritarchs observed from the Precambrian began to decrease in the Mesozoic period and have continued to be seen until today. There is an organic capsule surrounding these single-celled microorganisms. These single-celled microorganisms, called acritarchs, are surrounded by an organic capsule. These capsules, preserved as fossils, can be spherical, oval, polygonal, rectangular, triangular or spindle-shaped. The capsule wall may be one or two layered, and its surfaces may be smooth or ornamental (granular, tubercled, spiny, striped or reticulated, etc.). Some capsules are without extensions. Some have extensions of varying size and number. These extensions can be regular or irregular. Genus and species distinctions in acritarchs are generally made according to body shapes, symmetrical features, appendage structures, ornamental structures on the appendage and body, and appendage-stem relations. The most important reason why acritarchs are a fossil group used in the “Fossil Identification Software from Photograph (Fossil Vision)” is that the same genus and species have a similar appearance when evaluated in 2 dimensions, as in chitinozoans. Therefore, the software distinguishes between chitinozoans and acritarchs and groups fossil images belonging to the same genus, taking into account the morphological differences it visually detects.

Since many classes of chitinozoans and acritarchs have very similar appearances, and there are a large number of scientific fossil categories, the automated recognition system may be associated with a well-known low-resolution learning problem that is actively studied in computer vision research. Specifically, the challenges in the field can be listed as (i) the existence of multiple classes, (ii) similarities between classes, and (iii) changes within the classes themselves due to perspective changes. The third problem is particularly difficult as each fossil image is a random two-dimensional projection of a three-dimensional geometric object. In addition to the inherent difficulties of the problem, collecting samples is particularly difficult because collecting training samples for many classes requires collecting samples from many different physically remote areas, and some classes are much rarer than others. Therefore, the creation of a comprehensive fossil recognition system naturally coincides with the learning problem with a small number of examples, which models the newly seen classes with a limited number of training examples.

The two main steps of the method are explained below.

The stage of learning the representation of images: In this step, the aim is to learn sufficiently strong and explanatory features that strengthen the possibility of learning with a small number of examples. At this point, the use of deep convolutional neural networks, which have enabled important steps to be taken in similar problems such as the classification of everyday object images, has been deemed appropriate [1]. For this purpose, a convolutional neural network has been constructed using convolutional layers with nonlinear activation functions [1]. In this model, it is especially important that the fully connected linear transformation layer at the end takes the feature activations and converts them into classification scores. Details of the trained neural network architecture and system hyper parameters were adjusted using the validation set. For the purpose of obtaining visual features, a dataset containing a limited number of classes with sufficient samples (e.g. 50 samples) was used based on fully supervised learning and a fossil image classification system was trained.

The relevant dataset includes fossil images and their class labels. These images have been cut manually to contain a single sample, roughly centered and labeled by an expert in the field. In these training examples, multiclass cross entropy loss and back propagation stochastic gradient descent are used to fit the parameters of the deep neural network. The optimization hyperparameters of the neural network were adjusted by measuring the normalized classification accuracy value on the validation set, which was created to include samples from the same class.

The convolutional neural network-based visual classifier was used to obtain the features of the images after being trained once. For this purpose, the last fully connected layer was discarded and activation values before they were used to represent the images. This method is also widely used to obtain state-of-the-art features in different problems such as fine-grained visual classification with zero samples [2], object recognition with few samples [3], and object detection.

The last step of the method is to construct a meta learner to learn a new classifier for the purpose of recognizing classes with few examples. For this purpose, it has been observed that representation vectors based on the average of features [3][4] have been successfully used to learn to predict classification models, especially in different fields such as object and scene classification. Based on this observation, a similar helper learner method has been constructed for estimating models for fossil classification based on feature extraction.

For this purpose, first of all, convolutional neural network-based features were extracted for the classes determined for the use of the helper learner. In this way, it can be ensured that classes with few samples are also handled. The training scheme of the meta learner was determined as forming training groups with a limited number of training samples obtained from randomly selected subsets of the classes. The features of the selected classes were averaged and these were used as weight prototypes of a multi-class linear classifier for the respective class. A weight converter module with trainable parameters was used to convert these weight prototypes to actual weights. This module can be selected as affine, linear or multilayer depending on the normalized class performance of the validation set. The definitions in the following sections are based on the affine layer, similar to the example of cropped object examples with class labels [3].

In order to learn the trainable parameters of the mentioned meta learner, in addition to the training set-based groups, samples from the classes belonging to the validation set were selected, the cross-entropy loss was calculated depending on the weights produced, and the trainable parameters were updated using stochastic gradient descent. This approach was repeated more than once during the training to learn the final model parameters.

After the meta learner has been trained, it can be used to estimate new classification weights. For a new fossil class with a small number of examples, first of all, visual features are extracted, their class-based average is taken, and their weights are given to the obtained module in order to create the expected classification weights. Classification of a test sample is accomplished by selecting the class that gives the highest classification score.

Some definitions of the invention,
1. Raw pictures

These are high-resolution images that may contain more than one fossil object and their classes are unclear.
2. Manual labeling process

Marking the locations and class labels of fossil objects by the expert in the field
3. Examples of cut objects with class labels Raw images were processed according to the labels and matched with their labels
4. Elimination process by class size

The selection of classes with many (more than 40) instances.
5. Training classes with sample size higher than the set threshold (divided into training and validation clusters)

The division of classes with a large number of examples into the training set to be used for training purposes and the validation set to be used in the selection of hyperparameters.
6. Training with the help of validation

The use of training classes to determine the parameters of the model and validation classes to determine the hyperparameters of the model.
7. Convolutional Neural Network

A deep learning model with convolutional layers is learned by changing the parameters of the model at this stage.
8. Large (40+ instances) training and validation classes

The training set to be used for training purposes of classes with a large number of examples and the validation set to be used in the selection of hyperparameters.
9. Convolutional Neural Network (frozen)

A deep learning model with convolutional layers, at this stage, the parameters of the model are fixed and the model is used for feature extraction.
10. Visual features

Numerical representations obtained by processing the object images with the convolutional neural network.
11. Small size classes (with less samples than the specified threshold) as an example of few-shot learning

The classes that will be the subject of learning with few examples (less than 40 examples), the examples are relatively difficult to collect and there are few examples.
12. Validation Assisted Training

The process of training (learning its parameters) by using the validation set to learn the hyperparameters of the meta learner.
13. Inference

The introduction of the training set of the classes with a small number of examples to the meta-learner
14. Test

The test set of the classes with few examples is given to the meta learner.
15. Visual Features

The numerical representations obtained by processing the object images by the convolutional neural network.
16. Unseen test examples of classes with sample size less than the specified threshold.

A test set created to measure the performance of the model for classes with a small number of samples.
17. Meta Learner

The learner who will reach the classification weights from the limited number of training samples of classes with a small number of samples.
18. Class labels of unseen instances

Class labels predicted by the meta learner for instances in the test set of classes with a small number of instances.
19. Meta Learner: Training Phase (multiple episodes with i from 1 to n) The learner who will obtain the classification weights from a limited number of training samples of classes with small number of samples.

During the training phase of this learner, more than one subset is created and the parameters are updated sequentially over these subsets. The processing of each subset corresponds to one episode.
20. The visual features of the samples belonging to the training and validation sets of the large classes are numerical representations obtained by the convolutional neural network processing the object images of the large classes.
21. A random subset

It is the process of generating a random subset of large-sized classes.
22. Training group i

A random subset from the training set of large classes. It is used for training (determining the meta-learner's parameters) during episode i.
23. Validation group i

A random subset from the validation set of large classes. It is used for validation (determination of meta-learner's hyperparameters) during episode i.
24. Averaging of features based on class label

The average of the numerical features belonging to each class among themselves.
25. Hadamard multiplication (weights in training phase)

While the parameters of the meta learner are in the change/training phase, it is the product of the learned weights and the features, element-wise.
26. Classification weights

These are the classification weights learned by the meta learner and used to determine the labels of the features.
27. Class scores

They are the scores that will match the classes with the labels.
28. Meta-Learner: Test Phase

It is the stage of labeling the examples of the new classes in a fixed form of the parameters of the meta learner.
29. Visual feature from the training set of classes with less than the specified threshold value numerical representations obtained by processing the object images by the convolutional neural network. These examples come from a small training set of classes with a small number of samples.
30. Average of features

The averaging of numeric features from a single class.
31. Hadamard multiplication (weights frozen)

The product of the learned weights and the features, element-wise, while the parameters of the meta learner are fixed.
33. Classification weights

These are the classification weights learned by the meta learner and used to determine the labels of the features.
34. Class scores

Class scores predicted by the meta-learner for samples in the test set belonging to classes with a small number (less than 40) samples. Maximum scores are used to determine class labels.

Based on the detailed explanation above, the invention is a computer-based fossil recognition method with deep learning processes (using convolutional neural network and meta-learner);
Marking the fossil object types and locations by subjecting the raw pictures (2) to the manual labeling process (2),
Obtaining the cropped object examples (3) together with the class labels by cropping the objects using the locations taken from (2) for the manual labeling process,
The pictures obtained from the object samples (3) cropped together with the class labels are subjected to the elimination process (4) according to the sizes (magnitudes) of the classes (according to whether the samples belonging to the class are less than 40 or higher (according to the determined threshold value)),
Creation of large-sized (voluminous) (large-sized (more than 40 examples) with samples higher than the determined threshold value) training classes (5) obtained from the elimination process (4) according to class size,
Dividing training classes (5) with samples higher than the specified threshold value (Large size (voluminous)) into training and validation clusters and performing training (6) with the help of training validation under the supervision of the validation cluster,
Obtaining training (6) as a convolutional neural network (7) with the help of validation,
The convolutional neural network, which is learned by changing the parameters in the convolutional neural network (7), is used as a feature extraction method after its parameters are frozen (Convolutional Neural Network (frozen) (9)),
Generating visual features (10) by taking picture samples (8) of training and validation classes, which are higher than the specified threshold value, as input by the convolutional neural network (frozen) (9),
Learning an meta learner (17) using these visual features (10),
This meta learner (17), during inference, the pictures belonging to the training set of small-sized classes (small-sized) classes (11), which have less samples than the threshold value determined as the learning example with few samples (11), are extracted by the frozen convolutional neural network (frozen) (9). Taking the visual features (15) extracted by the frozen convolutional neural network (frozen) (9) as input,
Introducing training (12) and inference (13) with the help of validation to the meta-learner (17) of these classes with the help of visual attributes (15) belonging to the training set of classes with a small number of samples (less than the specified threshold value (less than 40),
Then, using the attributes belonging to the test set (15) of the classes with few examples during the test, the meta learner (17) predicts the class labels (18) of the examples of which the labels of these classes are not seen.

Training the aforementioned meta learner (17) by applying the inference (13) and the Meta Learner Training Stage (19) consists of the following steps;
For the numerical representations obtained by the convolutional neural network processing the object visuals of large-sized classes (with samples higher than the specified threshold (more than 40 samples)), it was determined that the visual features (21) and the visual features (15) of the training and validation sets of the classes with the large-sized sample were randomly selected from the training group i (22), validation group i (23) as subsets,
Training group i (random subset from training set belonging to large classes, training group i (24)) resulting from a random subset (21) is used for training (determining the meta-learner's parameters) during episode i,
Validation group i (a random subset from the validation set belonging to large classes, validation group i (23) resulting from a random subset 1 (21)) is used as a test set for validation (determining the hyperparameters of the meta-learner) during episode i,
The average of the features depending on the class label of the randomly generated training set (Training group i (22)) of the meta learner (17),
Obtaining the classification weights (26) by multiplying the learned weights and the features element-wise (Hadamard multiplication (weights at the training stage) (25)) with Hadamard multiplication (weights frozen) (32) while the parameters of the meta learner are at the change/training stage,
Using the obtained classification weights (26) for the classification of the randomly generated validation set and obtaining the class scores (27),
Using the aforementioned class scores (27) for feedback purposes and training the meta learner (17) by using the labels of the validation group i (23) since they are known The inference phase of the co-learner (17) mentioned above (testing (14), Meta-Learner:
Testing Phase (28)) consists of the following steps;
Averaging (31) visual features (15) obtained using visual features (29) from the training set of small size (with less than the specified threshold value (classes with less than 40 samples)) and images from both the training and test set. Averaging the numeric features from a class,
Then, these averages are subjected to Hadamard multiplication (the weights are frozen) (32) and the classification weights (33) are obtained,
These classification weights (33) are used together with the visual features (30) from the test set of small-sized classes (with samples less than the specified threshold value) to obtain class scores (34),
The class giving the largest of these scores should be evaluated as the classification result. The threshold value mentioned in the above methods is 40. This threshold value was chosen in accordance with the available data set. It is convenient to set it to be selected by the user according to the structure of the data set.

### REFERENCES

[1] Goodfellow, Ian, et al. Deep learning Cambridge: MIT press, 2016.
[2] Xian, Yongqin, Bernt Schiele, and Zeynep Akata. “Zero-shot learning—the good, the bad and the ugly.” Proceedings of the IEEE Conference on Computer Vision and Pattern Recognition. 2017.
[3] Gidaris, Spyros, and Nikos Komodakis. “Dynamic few-shot visual learning without forgetting.” Proceedings of the IEEE Conference on Computer Vision and Pattern Recognition. 2018.
[4] Snell, Jake, Kevin Swersky, and Richard Zemel. “Prototypical networks for few-shot learning.” Advances in neural information processing systems. 2017.

1. A method of computer-based fossil identification with deep learning processes, the method comprising the steps of:
marking fossil object types and locations by subjecting raw pictures to a manual labeling process;
using locations taken from the manual labeling process and cutting the objects to obtain cut object examples together with their class labels;
subjecting the pictures obtained from the cut object samples together with the class labels to an elimination process according to dimensions of the classes;
creating training classes with samples higher than a determined threshold value obtained from the elimination process according to class size;
dividing the training classes with samples higher than the determined threshold value into training and validation clusters, and performing the training with the help of validation under the supervision of the validation cluster;
obtaining training as a convolutional neural network with the help of validation;
using the convolutional neural network, which is learned by changing the parameters in the convolutional neural network as a feature extraction method after the parameters are frozen;
generating visual features by taking picture samples of training and validation classes, which are higher than the specified threshold value, as input by the convolutional neural network (frozen);
learning an meta learner by using the visual features produced;
taking the images belonging to the training set of small-sized classes (smallsized) classes, which have less samples than the threshold value determined as the learning example with few samples, the visual features which are extracted by the frozen convolutional neural network (frozen) and unseen test samples of classes with less than the specified threshold value, of the visual features which are extracted by the convolutional neural network (frozen) as input of the learned meta learner;
introducing training and inference with the help of validation to the meta learner of these classes with the help of visual features belonging to the training set of classes with less than the determined threshold value;
then, predicting the class labels of the examples of which the labels of these classes are not seen by the meta learner, by using the features of the test set of the classes with a small number of examples.

2. A method according to claim 1, wherein the training of the meta learner applying the inference and the Meta Learner Training Stage comprises:
processing the object images belonging to the classes with a sample higher than the specified threshold value for the numerical representations obtained by the convolutional neural network, the training and validation sets of the training classes with a sample higher than the specified threshold value were determined by the random training of visual features and visual features subsets as group i, validation group i;
forming the Training group i as a result of a random subset, is used for training to determine the parameters of the meta learner during episode i;
using Validation group resulting from a random subset 1 as a test set for validation during episodes i and i;
obtaining the average of the features depending on the class label for the training group i from the randomly generated training set of the meta learner;
obtaining the classification weights by multiplying the learned weights and the features by the element-wise while the parameters of the meta learner were in the change/training phase, with Hadamard multiplication (the weights were frozen);
using the obtained classification weights for the classification of the randomly generated validation set and obtaining the class scores;
using the aforementioned class scores for backpropagation purposes and training the meta learner by using the labels of the validation group i.

3. A method according to claim 1, wherein the inference phase (test, the Meta Learner Test Phase) of the meta-learner comprising:
taking the average of the visual features obtained by using the visual features from the training set of classes with less than the specified threshold value and the images from both the training and test sets and averaging the numerical features from a single class;
then, subjecting these averages to Hadamard multiplication (the weights are frozen) to obtain classification weights;
obtaining Class scores by using these classification weights together with the visual features from the test set of classes with samples less than the specified threshold value;
evaluating of the class that gives the largest class score as a classification result.

4. A method according to claim 1, wherein the determined threshold value is 40.

5. A method according to claim 1, wherein the elimination process according to whether the class sizes are higher or less than the determined threshold value.

6. A method according to claim 3, wherein the number of few visual features from the training set of classes with less than the specified threshold value mentioned in the method is less than 40.
